(19) United States
(12) Patent Application Publication
(10) Pub. No.: US 2016/0255845 A1
(43) Pub. Date: Sep. 8, 2016

(54) FOOD PREPARATION PROCESS

(71) Applicant: AMAIZE JOINT VENTURES, LLC, Boca Raton, FL (US)

(72) Inventors: Luis GINESTRA, Boca Raton, FL (US); Leonardo COTTER, Caracas (VE); Victor EGUI, Turmero (VE)

(21) Appl. No.: 15/030,244

(22) PCT Filed: Aug. 14, 2015
(86) PCT No.: PCT/US2015/045292

§ 371 Date: Apr. 18, 2016

Related U.S. Application Data
(60) Provisional application No. 62/037,338, filed on Aug. 14, 2014.

(51) Int. Cl. A21D 13/04; A21D 2/16; A21D 13/00

(52) U.S. Cl. CPC A21D 13/04; A21D 13/0025; A21D 2/165

(57) ABSTRACT

The system and methods of the present invention include techniques for food preparation. The food preparation process may include portioning a dough into dough portions using a portioning machine; pressing the dough portions to form dough discs using a press; heating the dough discs to produce baked dough discs using an oven; and grilling the baked dough discs to produce grilled dough discs using a broiler or grill.

### CROSS REFERENCE TO RELATED APPLICATIONS

The present application claims priority to U.S. Provisional Patent Application No. 62/037,338, filed on Aug. 14, 2014, which is incorporated herein by reference.

### FIELD OF THE DISCLOSURE

This disclosure relates generally to processes for preparing food and, more particularly, the preparation, forming, and cooking of arepas and similar food in a fast-casual restaurant setting.

### BACKGROUND

Fast casual restaurants are an increasingly popular type of restaurants which do not offer waited table service, but usually serve higher quality and more quickly prepared food items than typical fast food restaurants. Many fast casual restaurants incorporate an enhanced visual experience by allowing the customer to view the preparation of their meals. Typical fast casual restaurants permit customers to witness the assembly of their sandwiches, salads, burritos, or other dishes, thereby allowing the consumer to customize their dish as it is being assembled. Another hallmark of fast casual restaurants is the lower price compared to full service restaurants.

One popular food dish not commonly offered by fast causal restaurants are arepas. Arepas are somewhat similar to flatbread or even English muffins. Arepas are particularly popular in South and Central American countries, namely Venezuela and Colombia, and are growing in popularity in the United States. Arepas derives its name from the word “Erepa,” the indigenous word for corn bread. A plain arepa is a round, thick bread and may be formed from dough or ground maize based mixture. Initially, arepas were eaten primarily as a bread accompanying food or filled simply with just cheese. Nowadays arepas are filled with meat, pork, chicken, fish, vegetables, fruits, jellies, jams, chocolate, and numerous other fillings or toppings.

Arepas are ideally formed and cooked into a shell having a crunchier outside with a softer inside. The softer inside may then be filled with the aforementioned fillings or toppings. Arepas may come in various sizes and can be grilled, fried, or baked. Fully cooked and prepared arepas may weigh between about 3 to 5 ounces, have a diameter between about 4 to 6 inches, and may have a thickness between about 0.3 to 0.8 inches. Smaller sized arepas, portioned for instance for children, may weigh between about 2 and 3 ounces, have a diameter between about 3 and 4 inches, and may have a thickness between about 0.25 to 0.9 inches. Arepas can dry very quickly during the cooking process due to an imbalance of water in the arepa dough. If the arepa is too dry, the edges and exterior of the arepa will begin to crack when attempting to form the arepas. Furthermore, arepas become very dense as they cool after grilling, frying or baking, and therefore, should usually need to be eaten when hot and freshly made.

Traditionally, arepas are cooked at home where small batches of freshly-made arepas stay warm while maintaining their crunchy exterior and moist interior. Re-creating freshly-made arepas in a fast-casual restaurant setting has always been difficult as most traditional recipes are for homemade purposes to make small batches of arepas at a specific size. As mentioned above, homemade arepas can easily dry and crack during the mixing process and become dense and hard as they cool after cooking. These cooking obstacles become greater when attempting to make arepas daily in mass quantities such as in fast-casual restaurants using commercial cooking equipment. Restaurants may sell thousands of arepas a day in numerous sizes that require consistency, as well as the taste and texture of freshly-made, homemade arepas.

In light of the challenges associated with making large quantities of arepas in a restaurant setting, there is a need in the art for a process that re-creates consistent and freshly made arepas at fast-casual restaurants.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one embodiment, the food preparation process may include portioning a dough into dough portions using a portioning machine; pressing the dough portions to form dough discs using a press; heating the dough discs to produce baked dough discs using an oven; and grilling the baked dough discs to produce grilled dough discs using a broiler or grill.

In one aspect, the present disclosure provides a method for preparing consistently fresh arepas for restaurants, including fast-casual restaurants. Fast-casual restaurants may produce hundreds or thousands of arepas or similar food items daily. Arepas that crack in the oven or become dense after grilling or baking are common problems with arepas made at home. Therefore, restaurants and fast-casual restaurants face the challenge of making hundreds of arepas daily that remain consistent with size and texture during preparation and maintain a crunchy exterior and moist interior after cooking.

In another aspect, the present disclosure provides a method for preparing arepas or other baked or grilled food items using restaurant-grade equipment. Fast-casual restaurant kitchens are equipped with restaurant cooking equipment that need to produce the hundreds of arepas made daily but with the qualities of a fresh, homemade arepa.

In another aspect, the present disclosure provides a method for preparing arepas or other baked or grilled food items such as pizza and sandwiches where customers or general public may view the preparation process. A fast-casual restaurant may display all the cooking equipment used to mix, form, and grill arepas allowing customers to view the process. In addition, the process allows a restaurant to assemble the finished product in front of the customer ordering the arepa or other baked or grilled food item.

In yet another aspect, the present disclosure provides a method for preparing consistently fresh and high quality arepas in various diameters and thickness. Arepas may come in various sizes including regular-sized arepas to junior-sized arepas for children or smaller snacks. This food preparation process for arepas and other baked or grilled food items allows a restaurant to prepare various sizes of arepas that maintain the same high quality and consistency of freshly, homemade arepas.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIG. 1 illustrates a flow chart of a process for making a food product, in accordance with embodiments of the disclosure;

FIG. 2 illustrates a flow chart for an embodiment of a mixing step as part of the process of FIG. 1;

FIG. 3 illustrates a flow chart for an embodiment of a forming step as part of the process of FIG. 1;

FIG. 4 illustrates a flow chart for an embodiment of a cooking step as part of the process of FIG. 1;

FIG. 5 illustrates various arepas including generally desirable qualities of an arepa after the mixing step, forming step, and cooking step of the process of FIG. 1.

FIG. 6 illustrates various arepas including generally desirable qualities of an arepa after the grilling stage of the cooking step of the process of FIG. 1.

FIG. 7 illustrates a flow chart for an embodiment of an assembly step as part of the process of FIG. 1.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

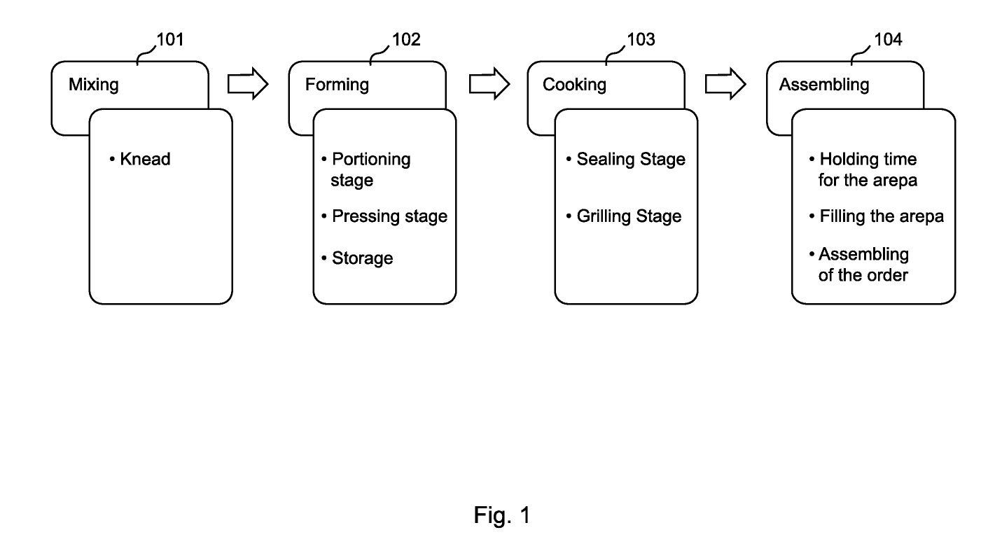

FIG. 1 illustrates one embodiment of a process for preparing foods such as arepas. In step 101, a mixing step may allow a plurality of ingredients to be mixed and kneaded to form an arepa dough. In step 102, a forming step may include a portioning stage and a pressing stage that may produce a plurality of formed dough discs in specific sizes. In step 103, a cooking step may include a sealing stage and grilling stage to cook the formed arepa discs using a plurality of cooking equipment to produce a cooked arepa. In step 104, the cooked arepa is filled and assembled with a plurality of fillings for sale and consumption.

This process may be utilized for preparing arepas, but other baked or grilled items are contemplated within the disclosure, for instance, pizza, gorditas, pupusas, sandwiches, flatbreads, or other items particularly requiring baking or grilling. Embodiments of the process for preparing food may be incorporated into a restaurant, such as a fast casual restaurant where customers may view at the least the assembling step, and in some embodiments the mixing step, the forming step, the cooking step, or a combination of steps thereof as well.

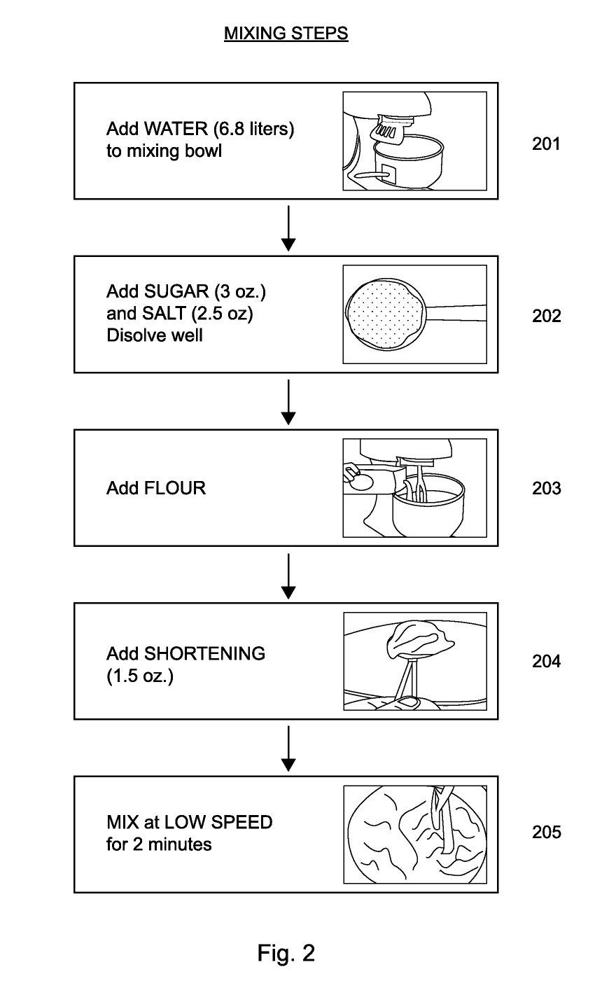

FIG. 2 illustrates one embodiment of the mixing step for preparing foods such as arepas. In step 201, a predetermined amount of water or another fluid may be measured and added to a mixing bowl. In one embodiment, approximately 6.8 liters (28 cups or 1.8 gallons) of water may be measured into a mixing container. In step 202, approximately 3 ounces of salt and approximately 2.5 ounces of sugar may be added and dissolved to the water to make a water solution. In step 203, approximately 4 kilograms of flour may be stirred into the water solution to make an arepa dough. In step 204, approximately 1.5 ounces of vegetable oil may be added to the arepa dough. In another embodiment, corn oil or other type of fat or shortening may be used instead of vegetable oil. In step 204, the arepa dough may be mixed or kneaded at a low speed using a mixer. In one embodiment, the mixer may be a Hobart mixer.

In one embodiment of step 203, clumping may be avoided by first adding and stifling about a half of the flour or about 2 kilograms of the 4 kilograms of flour into the water solution. After mixing the first half of the flour, the other half or 2 kilograms of the flour may be added and mixed. In one embodiment, the flour may be precooked cornmeal or precooked corn flour.

In another embodiment, the arepa dough may be kneaded for approximately two minutes in step 205. After mixing for approximately two minutes, the arepa dough may be removed from the mixing container and generally formed into a ball in preparation for the forming step.

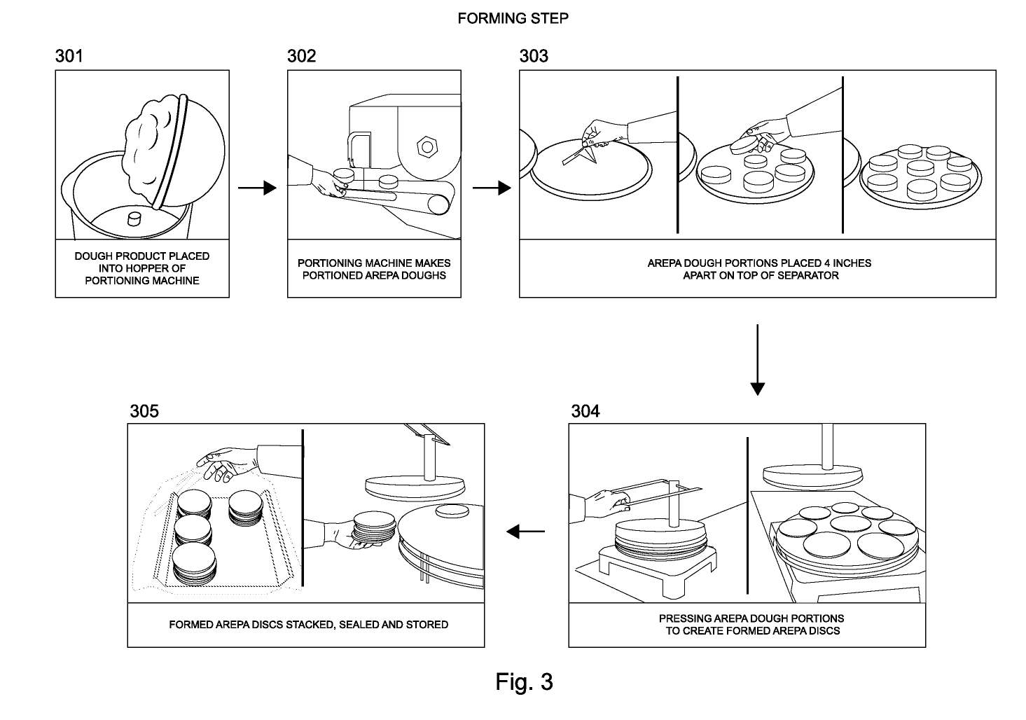

FIG. 3 illustrates an embodiment of the forming step for preparing foods including a portioning stage and a pressing stage of the forming step. The portioning may be implemented through use of a forming machine or portioning machine such as those sold by La Minerva (e.g., models C/E652, C/E653, etc.). The pressing stage may be implemented through use of a press such as those sold by DoughXpress (e.g., model TXM-15CP).

In step 301, the arepa dough is placed in a hopper of a formatic portioning machine which may be set to a desired arepa size. In step 302, the portioning machine may make a plurality of arepa dough portions. In one embodiment, the portioning step may include discarding the first several arepa dough portions and readjusting the formatic portioning machine to repeat step 302 until arepa dough portions are consistently produced of at the desired size. When the desired size of the arepa dough portions are produced, the arepa dough portions may be placed on a forming machine in preparation for the pressing stage in step 303. In step 303, the arepa dough portions may be placed approximately 4 inches apart on top of a separator, and a second separator may be placed on top of the arepa dough portions. In one embodiment, the first and second separators may be an acrylic mat. In step 304, the arepa dough portions may be pressed to form a plurality of formed arepa discs by using the forming machine to press the arepa dough portions into calibrated sizes. In step 305 and prior to the cooking step, the formed arepa discs may be stacked, sealed, and stored for up to 180 minutes.

Portioning and forming machines may be used for forming food items ranging from meat and poultry to confectionary items. Such portioning and forming machines may be utilized in embodiments of the disclosure as part of the process for preparing arepas. Once the dough is placed in the formatic portioning machine in step 301, the formatic machine may then be set depending on the desired arepa size. The formatic portioning machine may then be activated in order to form premade sizes of formed arepa dough. Once portioned, the arepa dough portions may then be pressed into a patty shape in preparation for cooking by using the press or forming machine in steps 303 and 304. In one embodiment, the press machine may be a MeatXpress press or forming machine. Since the forming step includes a portioning stage and a pressing stage, the portioning machines and the presses are both referred to as forming machines as they are both used in the forming process. The press or forming machine may permit simultaneous pressing of numerous arepa dough portions into formed arepa discs ready for cooking. In another embodiment, the formed arepa discs may be stacked in rows that may include about 4 to 6 formed arepa discs in each stack.

In one embodiment, a regular-size arepa dough portion's weight may be set about 5.4 and 5.8 ounces in the formatic portioning machine while a junior-sized arepa dough portion's weight may weigh be set about 2.6 and 3 ounces in the formatic portioning machine. For these embodiments, a regular-sized arepa dough portion may then be pressed into a regular-sized formed arepa disc having a height or thickness between about 0.37 and 0.57 inches with an average diameter between about 4.9 and 5.1 inches, and a junior sized arepa dough portion may then be pressed into a junior-sized formed arepa disc having a height or thickness between about 0.37 and 0.57 inches with an average diameter between about 3.0 and 4.0 inches. Tables 1 and 2 below present alternative quality parameters for the product throughout the disclosed process.

TABLE 1
Regular Size Arepa quality parameters in process and finished product

| Parameters | Portioning | Pressing | Sealing | Grilling |
|---|---|---|---|---|
| Weight (ounces) | 5.64 ± .2 | 5.64 ± .2 | 4.40 ± 4 | 4.05 ± 3 |
| Diameter (inches) | 3.14 ± .1 | 5 ± .1 | 4.2 ± 5 | 4.92 ± 5 |
| Thickness (inches) | 1.37 ± 1 | 0.7 ± 1 | 0.55 ± 2 | 0.55 ± 2 |
| Temp. (° F.) | 68 − 77 | 68 − 77 | 425 − 475 | 450 − 465 |

TABLE 2
Jr Arepa-quality parameters in process and finished product

| Parameters | Portioning | Pressing | Sealing | Grilling |
|---|---|---|---|---|
| Weight (ounces) | 2.82 ± 2 | 2.82 ± 2 | 2.61 ± 2 | 2.32 ± 2 |
| Diameter (inches) | 3.14 ± 0.1 | 3.54 ± 5 | 3.54 ± 5 | 3.54 ± 5 |
| Thickness (inches) | 0.59 ± 1 | 0.47 ± 01 | 0.47 ± 1 | 0.59 ± 3 |
| Temp. (° F.) | 68 − 77 | 68 − 77 | 425 − 475 | 450 − 460 |

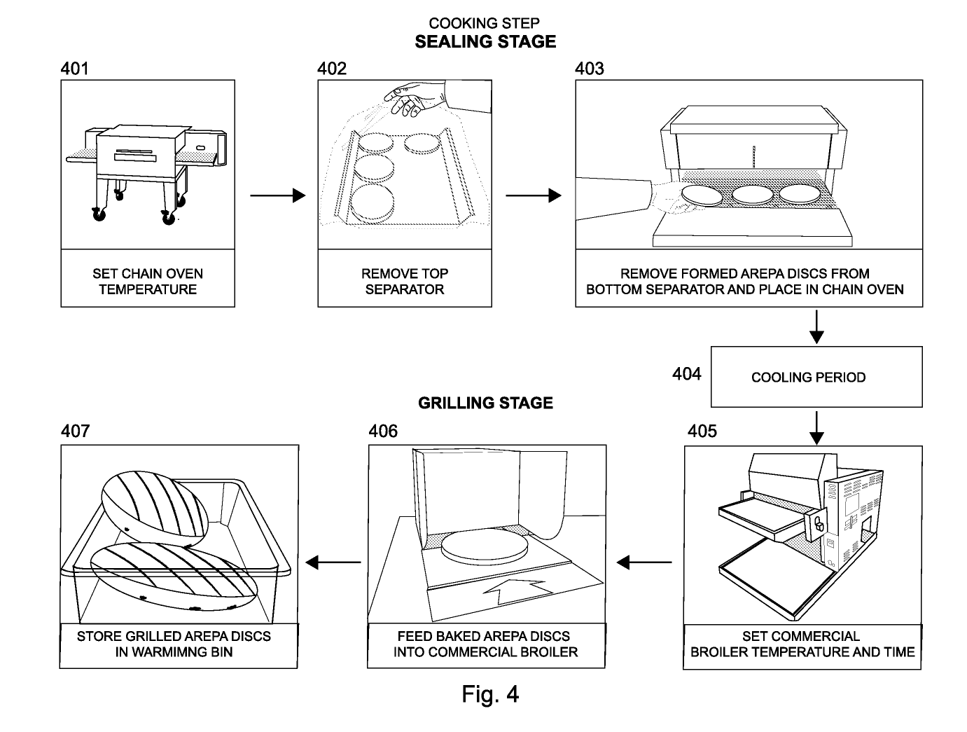

FIG. 4 illustrates an embodiment of the cooking step including a sealing stage of the cooking step and a grilling stage of the cooking step. In one embodiment, a conveyor oven (alternatively referred herein as a “chain oven”) may be utilized as part of the sealing stage of the cooking step. In one embodiment this conveyor oven may be a Lincoln conveyor oven (e.g., model CTI 1300, CTI 2500, etc.). In step 401, the chain oven may be preset to a predetermined cooking time and temperature in order to permit a baking process as part of the sealing portion of the cooking step. In one embodiment, the chain oven may be warmed from 425 to 475 degrees Fahrenheit and set to a travel time of approximately 7.25 minutes. In step 402, the top separator covering the formed arepa discs may be removed. In step 403, the formed arepa discs may be removed from the bottom separator and placed in the chain oven next to each other. The chain oven produces a plurality of baked arepa discs and allows the baked arepa discs to be sealed on all sides. In step 404, the baked arepa discs may be left to cool, either at room temperature or under heat lamps, for about 15 to 25 minutes prior to proceeding to the grilling portion of the cooking step. In another embodiment, the baked arepa discs may be placed straight into a commercial broiler. In step 405, a commercial broiler may be utilized as part of the grilling stage of the cooking step, and the broiler may be set to a predetermined temperature and cooking time. In one embodiment, the predetermined temperature and cooking time may be about 450 to 460 degrees Fahrenheit for about one minute. In step 406, the baked arepa discs may be fed individually or one at a time to the commercial broiler to produce a plurality of grilled arepa discs. In another embodiment, an automatic stacking system on the broiler may be used to feed the baked arepa discs into the broiler by stacking up to 4 baked arepa discs at one time. In step 407, the grilled arepa discs may be stored, either in a warming bin or at room temperature.

When the formed arepa discs are being prepared for the chain oven, one embodiment of the process may include spreading or smearing oil, such as corn oil, on one or both sides of each formed arepa disc in order to discourage sticking to the chain oven or cracking. The grilling stage may thereby create grill marks and provide a desired, crunchy texture to the outside of the arepa, while maintaining the desired soft texture of the inner portion of the arepa. In one embodiment, the boiler may be a commercially sold Nieco broiler (e.g., model JF-63). The Nieco broiler provides the heat and flavor of a freshly-made arepa. It should be understood and appreciated that other devices are contemplated for completing the grilling portion of the cooking step, including for instance a standard gas, electric, charcoal grill, or even a flat griddle. Similarly, other known or to be developed oven or heating devices are contemplated as part of the sealing portion of the cooking step as described herein.

After the sealing process of the cooking step, a regular-sized, baked arepa disc's weight may be about 4 to 4.8 ounces and a junior-sized, baked arepa disc's weight may be about 2.4 to 2.8 ounces. The regular-sized, baked arepa disc's diameter may be about 4.4 to 5.4 inches, and the junior-size, baked arepa disc's diameter may be about 3 to 4 inches. The height or thickness of the regular-sized, baked arepa disc may be about 0.35 to 0.75 inches, and the height or thickness of the junior-sized, baked arepa disc may be about 0.37 to 0.57 inches. After the grilling process of the cooking step, a regular-sized grilled arepa disc's weight may be about 3.7 to 4.4 ounces, and a junior-sized, grilled arepa disc's weight may be about 2.1 to 2.5 ounces. The regular-sized, grilled arepa disc's diameter may be about 4.4 to 5.4 inches, and the junior-sized, grilled arepa's diameter may be about 3 to 4 inches. The height or thickness of the regular-sized, grilled arepa disc may be about 0.35 to 0.75 inches, and the height or thickness of the junior-sized, grilled arepa disc may be about 0.3 to 0.9 inches.

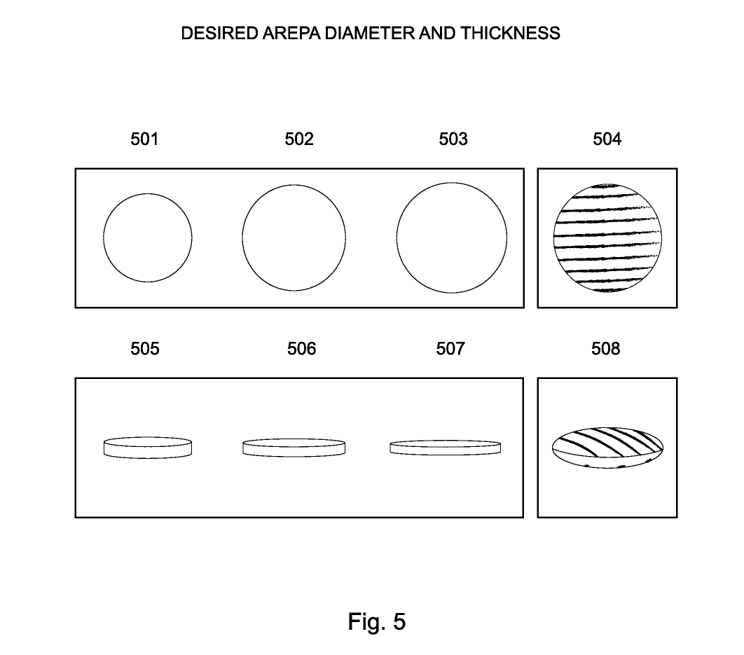

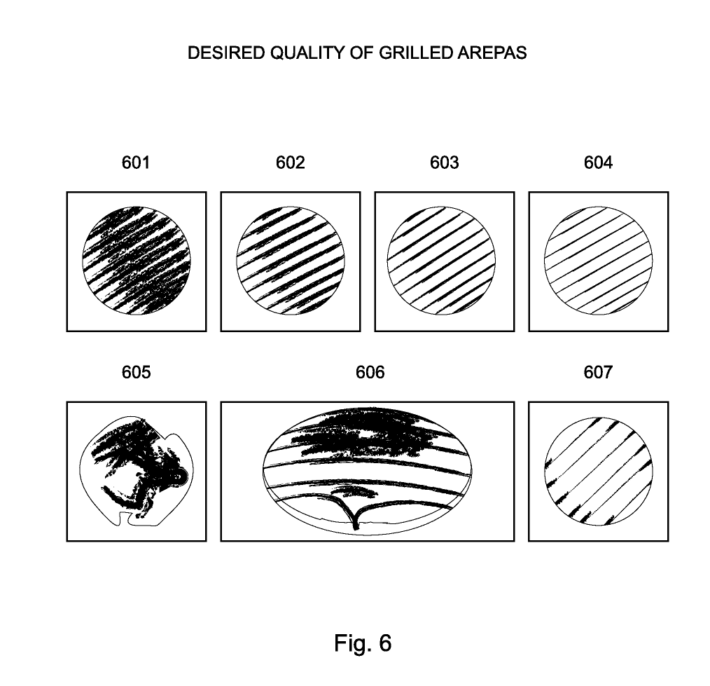

Prior to completing the assembly step, where an operator of embodiments of the process as described herein is utilizing the process for preparing arepas, the operator may refer to FIGS. 5-6 in order to ensure an ideal or preferred regular-sized arepa was made at each step of the process. As illustrated in FIG. 5, a regular-sized arepa diameter size may be compared at the portioning stage 501, the forming stage 502, the sealing stage 503, and the grilling stage 504. Furthermore, the height or thickness of the regular-sized arepa may be compared at the portioning stage 504, forming stage 505, sealing stage 507, and grilling stage 508.

As illustrated in FIG. 6, the quality of a grilled arepa disc may be compared for grill marks on the outside of the grilled arepa disc and inflation of the hollow interior of the grilled arepa disc. The grilling on the grilled arepa disc may be compared to a burnt grilled arepa disc 601, an over-grilled arepa disc 602, an ideal grilled arepa disc 603, and an under-grilled arepa disc 604. The inflation of the hollow interior of the grilled arepa may be compared to an over-inflated grilled arepa 605, an ideal inflated arepa disc 606, and a non-inflated grilled arepa disc 607.

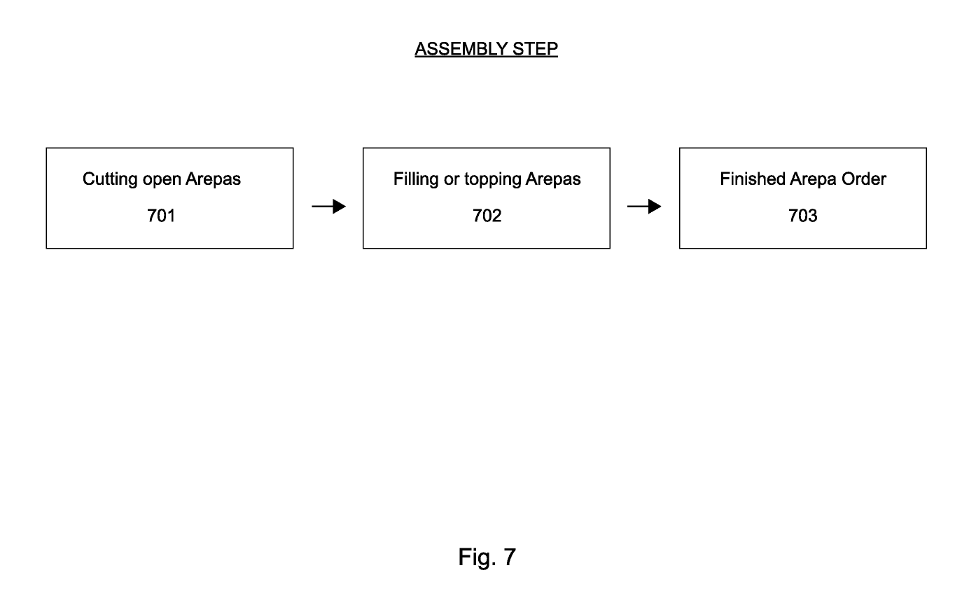

FIG. 7 illustrates an embodiment of the assembly step for the process of preparing foods including arepas. Once the grilled arepa disc complies with the ideal or preferred arepa from FIG. 6, the assembly step allows the grilled arepas disc to be filled or covered with desired toppings, fillings, or seasonings. In step 701, the grilled arepa discs may be opened by using a cutting tool such as a serrated knife to slice through the middle of the sealed grilled arepa disc. In this embodiment, a top half of the grilled arepa disc may be sliced leaving a bottom half of the grilled arepa disc sealed. This may prevent spilling or leaking of fluid from certain fillings. In step 702, the sliced grilled arepa disc may be filled with cheese, meat, chicken, fish, pork, vegetables, fruit, or other fillings. In another embodiment, the grilled arepa discs may be left sealed and toppings may be added to the top portion of the grilled arepa discs. Once filled or topped with requested fillings or toppings, a finished arepa may be presented to the customer in step 703.

Furthermore, the assembly step may be viewed by customers or general public as an assembler may slice the grilled arepa discs and prepare the fillings as desired by the customer. In another embodiment, a plurality of assemblers may slice the grilled arepa discs and place the fillings, toppings, or seasonings similar to an assembly line production.

The descriptions below provide alternative instructions for implementing the food preparation process of the disclosure.

Kneading—Preparation of the Dough for Arepas

Step 1—Measure water using the 28 cup capacity plastic container and add it to the mixer bowl. Add the salt and sugar to dissolve.

Step 2—Stir in 4 kg of flour. To avoid clumping first add 2 kg and then add the rest.

Step 3—Add 1.5 oz of Vegetable Oil.

Step 4—Start kneading for 2 minutes at the lowest speed.

Step 5—Stop the mixer and remove the bowl with the dough and mixing blade.

Step 6—Clean the blade with silicone palette and form a ball of dough to place in a bowl.

Portioning and Forming of Dough Disks

Step 1—Place the ball of dough in the hopper of the Formatic Machine.

Step 2—Set Formatic portioning machine depending on the type of corn bread or product to develop (see Table 3). Set the portioning adjustment slider on a La Minerva portioner to position 1 or 2 depending on the desired type of arepa cylinder.

Step 3—Start the machine and produce about 5 servings, discard the first two and take the average weight of the last 3, and if the weight falls within the range specified in Table 3, remove the portions needed and continue the forming operation; otherwise, return to step 2 and adjust the slider to achieve the desired weight range. The unused dough can be returned to the portioning hopper again (assuming there are no contamination issues).

Step 4—Using the floor pedal, start or stop the machine according to the number of servings required.

Step 5—Using calipers measure thickness produced before use of MeatXpress press machine.

Step 6—Use the MeatXpress to form the dough disks. Place the MeatXpress forming acrylic mats as required. Put the dough portions in the press along with the separator, leaving up to 10 cm gap between them. Place another acrylic mat on top of the dough. Close the top tray and lower the bar to put pressure on the dough and form disks. Avoid too much force or pressure on the bar.

Step 7—Raise the bar and open the top tray, remove the acrylic mats to see the formed arepas and stack the arepas in rows of 4 to 6 units. Seal the trays with plastic wrapper. One can store the dough disks for 90 minutes at room temperature between 15 and 30° C., preferably in trays or containers. It can also be cooled to 4° C. for up to 4 hours.

TABLE 3
Parameters to work with the Portioning and Forming equipments.

| | Formatic | | | | | |
|---|---|---|---|---|---|---|
| | Portioner | | Forming MeatXpress | | | |
| | Dough | | Avg | | | |
| Type of | Weight | Belt | Height | | # Of | Avg |
| Arepa | (oz) | position | (inch) | Splitter | Portions | Diameter |
| Reg Size | 5.46 ± 2 | (Pos. 2) | 0.47″ | 18 × 50 | 5 | 0.51″ |
| Jr Arepa | 2.82 ± 2 | (Pos. 1) | 0.47″ | 10 × 50 | 9 | 3.30″ |

Sealing or Baking Process Using Conveyor Oven

Step 1—Turn on chain oven 30 minutes before starting the process and set to 475° F. and a travel time of 7.25 minutes.

Step 2—Remove the top acrylic mat covering the arepas already formed, and apply corn oil on the top side of each dough disk/corn cake.

Step 3—Remove separators and place the dough disks in the chain oven next to each other. Apply corn oil on the other side of each dough disk.

Repeat steps 2 and 3 to get the necessary amount of arepas. After the arepas go through the baking process and come out of the oven, place the arepas under heat lamps for at least 20 minutes. The arepas can alternative be grilled or placed in broiler instead of being placed under the heat lamp.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document is hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

What is claimed:

1. A food preparation process comprising:
portioning a dough into a plurality of dough portions using a portioning machine;
pressing said plurality of dough portions to form a plurality of dough discs using a press;
heating said plurality of dough discs to produce a plurality of baked dough discs using an oven; and
grilling said plurality of baked dough discs to produce a plurality of grilled dough discs using a broiler or grill.

2. The process of claim 1, wherein said dough is produced by mixing water and precooked cornmeal or precooked corn flour.

3. The process of claim 1, wherein said dough is produced by mixing approximately 6.8 liters of water, approximately 3 ounces of salt, approximately 2.5 ounces of sugar, approximately 4 kilograms of flour, and approximately 1.5 ounces of oil or shortening for approximately two minutes to produce the dough.

4. The process of claim 3, wherein a mixer set at a low speed or medium low speed is used for mixing and the flour comprises precooked cornmeal or precooked corn flour.

5. The process of claim 3, wherein approximately half of the 4 kilograms of flour is added to the water, salt, and sugar at the start of the mixing step and approximately a second half of the 4 kilograms of flour is added at approximately one minute after the start of the mixing step.

6. The process of claim 1, wherein said dough portions may have a weight in the range of 5.4 to 5.8 ounces.

7. The process of claim 1, wherein said dough portions may have a weight in the range of 2.6 to 3.0 ounces.

8. The process of claim 1, wherein said dough portions are placed on top of a separator approximately 4 inches apart.

9. The process of claim 1, wherein said formed dough discs may have a diameter in the range of 4.9 to 5.1 inches and a thickness in the range of 0.37 to 0.57 inches.

10. The process of claim 1, wherein said formed dough discs may have a diameter in the range of 3.0 to 4.0 inches and a thickness in the range of 0.37 to 0.57 inches.

11. The process of claim 1, wherein said oven is set to a temperature in the range of about 425° F. to 475° F.

12. The process of claim 1, wherein said broiler is set to a temperature in the range of about 450° F. to 460° F.

13. The process of claim 1, wherein said oven is a conveyor oven.

14. The process of claim 1, further comprising letting the baked dough discs rest after completion of the heating step and before the grilling step.

15. The process of claim 3, wherein said oil or shortening comprises vegetable oil.

16. The process of claim 3, wherein said oil or shortening comprises corn oil.

17. The process of claim 1, wherein said baked dough discs are not fully baked at a time before said grilling.
